(19) United States
(12) Patent Application Publication
(10) Pub. No.: US 2024/0297382 A1
(43) Pub. Date: Sep. 5, 2024

(54) POWER STORAGE DEVICE

(71) Applicant: Prime Planet Energy & Solutions, Inc., Tokyo (JP)

(72) Inventor: Kazuki OSHIMA, Himeji-shi (JP)

(21) Appl. No.: 18/436,031

(22) Filed: Feb. 8, 2024

(30) Foreign Application Priority Data
Mar. 1, 2023 (JP) 2023-031352

(51) Int. Cl. H01M 50/176; H01M 50/191; H01M 50/198; H01M 50/55

(52) U.S. Cl. CPC H01M 50/176; H01M 50/191; H01M 50/198; H01M 50/55

(57) ABSTRACT

A power storage device disclosed herein includes a case body, a sealing plate having a terminal fit hole, an electrode body accommodated inside the case body, a collector terminal, and an insulating member arranged between the sealing plate and the collector terminal. In the power storage device, the insulating member is arranged at a periphery of the terminal fit hole of the sealing plate while being molded integrally with a peripheral portion of the terminal fit hole and the collector terminal. The sealing plate and the collector terminal are each composed of a metallic material having 0.2% proof strength and rupture elongation falling within respective predetermined ranges.

### CROSS REFERENCE TO RELATED APPLICATION

The present application claims priority from Japanese Patent Application No. 2023-031352, filed on Mar. 1, 2023. The entire teachings of this application are incorporated into the present specification by reference.

### BACKGROUND OF THE DISCLOSURE

### 1. Field

The present disclosure relates to a power storage device.

### 2. Background

Secondary batteries such as lithium ion secondary batteries and capacitors such as lithium ion capacitors belong to so-called power storage devices that become widely used as portable power sources for personal computers or mobile terminals, and also as power sources for driving vehicles such as plug-in hybrid electric vehicles (PHEV), hybrid electric vehicles (HEV), and battery electric vehicles (BEV).

Power storage devices for such purposes of use include a power storage device having a configuration where an electrode body having a positive electrode and a negative electrode is accommodated in a metallic case of a so-called square form having a hexahedron shape composed of rectangular six sides. As a typical example, a power storage device having such a configuration includes a square case body with an opened one side and a rectangular plate-like sealing plate (lid body) closing this opening part, and respective collector terminals for a positive electrode and a negative electrode electrically connected to the positive electrode and the negative electrode respectively of an electrode body to be accommodated in a case are passed through respective terminal fit holes for the positive electrode and the negative electrode provided at the sealing plate to locate parts of the terminals on an outer surface of the sealing plate.

A power storage device of this type includes a sealed power storage device prepared as follows. While an insulating member made of synthetic resin is arranged in advance at a peripheral portion of the terminal fit hole, an assembly with the sealing plate and the collector terminal (hereinafter called a “collector terminal-sealing plate assembly”) is molded integrally using a predetermined die by fitting the collector terminal to the sealing plate while passing a part of the collector terminal through the fit hole. An electrode body having a predetermined shape is connected to the integrally-molded collector terminal-sealing plate assembly, and a resultant member is accommodated in a body of a case, and the sealing plate is joined to an opening part of the case.

For example, Japanese Patent Application Laid-Open No. 2021-86813 describes an example of a sealed power storage device (lithium ion secondary battery) manufactured by using such an integrally-molded collector terminal-sealing plate assembly.

### SUMMARY

In a power storage device where a collector terminal-sealing plate assembly such as that described in JP2021-86813A and a case body are welded to each other, it is likely that, as a result of integral molding, rigidity will become higher at a part where a sealing plate, a collector terminal, and an insulating member are molded integrally than at other parts (a part not involved in the integral molding). In particular, the sealing plate and the collector terminal are each composed of a stout material so as to satisfy a predetermined strength. This is considered to make rigidity likely to become high at the integrally-molded part. Examination conducted by the present inventors shows that, if the sealing plate is subjected to a stress applied in a situation of some kind, the stress concentrates on a part of relatively low rigidity so rupture is likely to occur at the part not involved in the integral molding (for example, a welded part provided along a boundary between the sealing plate and the case body).

The present disclosure has been made in view of this issue, and an object of the present disclosure is intended to improve the safety to the power storage device in which a case body is welded to a collector terminal-sealing plate assembly in which a collector terminal and an insulating member are molded integrally with a sealing plate.

A power storage device disclosed herein includes: a case body having an opening part; a metallic sealing plate having a terminal fit hole and closing the opening part; an electrode body accommodated inside the case body; a collector terminal having one end electrically connected to the electrode body inside the case body and the other end exposed on an outer surface side of the sealing plate; and an insulating member arranged between the sealing plate and the collector terminal. The insulating member is arranged at a periphery of the terminal fit hole of the sealing plate while being molded integrally with a peripheral portion of the terminal fit hole and the collector terminal. The sealing plate is composed of a metallic material having 0.2% proof strength A from 95 to 350 N/mm² and rupture elongation X from 4 to 27%, and the collector terminal is composed of a metallic material having 0.2% proof strength B from 25 to 200 N/mm² and rupture elongation Y from 20 to 45%. In the power storage device, a ratio (B/A) of the proof strength B to the proof strength A is from 0.08 to 0.8, and a ratio (Y/X) of the rupture elongation Y to the rupture elongation X is from 1.1 to 10.8.

This configuration makes it possible to reduce rigidity favorably at a part where the sealing plate, the collector terminal, and the insulating member are molded integrally, so that a difference in rigidity can be reduced between the integrally-molded part and a part not involved in the integral molding (welded part, for example). This can reduce the occurrence of stress concentration to realize a power storage device of high safety.

In the present specification, “0.2% proof strength (N/mm²)” and “rupture elongation (%)” about a metallic material are values determined in conformity with JIS Z2241 using a JIS No. 13B test piece, unless otherwise specified. Furthermore, the 0.2% proof strength may simply be called “proof strength.”

### BRIEF DESCRIPTION OF THE DRAWINGS

FIG. 1 is a perspective view schematically showing a battery according to an embodiment;

FIG. 2 is a view schematically showing an internal configuration of the battery according to an embodiment;

FIG. 3 is a view schematically showing the configuration of an electrode body;

FIG. 4 is a view schematically showing a collector terminal-sealing plate assembly where a sealing plate, a collector terminal, and an insulating member are molded integrally;

FIG. 5 is a sectional view schematically showing a collector terminal and the vicinity thereof according to an embodiment; and

FIG. 6 is a view schematically showing a molding die according to an embodiment.

### DETAILED DESCRIPTION OF THE PREFERRED EMBODIMENTS

Hereinafter, embodiments of a technology disclosed herein will be described by referring to the drawings. Any feature other than features specifically set forth in the present specification and necessary for carrying out the technology disclosed herein (such as a general configuration of and manufacturing process for a power storage device not characterizing the technology disclosed herein, for example) can be understood as a design matter that a person skilled in the art can address on the basis of conventional technology in the pertinent field. The technology disclosed herein can be carried out on the basis of a substance disclosed in the present specification and technical knowledge in the pertinent field. Each drawing is drawn schematically and dimensional relationships (length, width, thickness, etc.) do not necessarily reflect actual dimensional relationships. Moreover, in each drawing referred to below, members and parts having the same function will be given the same reference numerals, and redundant description thereof may be omitted or simplified. In addition, an expression “from A to B” indicating a range in the present specification (A and B are any numerical values) means a range equal to or greater than A and equal to or less than B.

In the present specification, a “power storage device” is a device where charging and discharging reactions occur in response to transfer of a charge carrier between electrodes in a pair (positive electrode and negative electrode) across an electrolyte. This power storage device includes: secondary batteries such as lithium ion secondary batteries, nickel hydride batteries, and nickel cadmium batteries; and capacitors such as lithium ion capacitors and electric double layer capacitors (namely, physical batteries).

Embodiments of the technology disclosed herein will be described below by using a lithium ion secondary battery as an example out of these power storage devices.

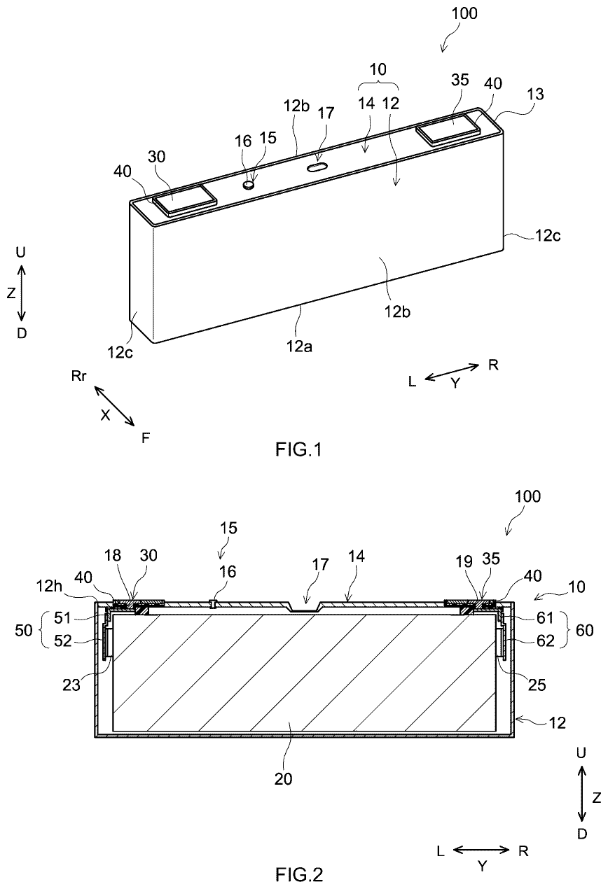

FIG. 1 is a perspective view of a secondary battery 100 according to the present embodiment. FIG. 2 is a view schematically showing an internal configuration of the secondary battery 100. In the following description, signs X, Y, and Z in the drawings indicate a short side direction of the secondary battery 100, and a long side direction perpendicular to the short side direction respectively, and a top-bottom direction. Furthermore, signs L, R, F, Rr, U, and D in the drawings indicate left, right, front, rear, up, and down respectively. However, these directions are defined for the convenience of description and are never intended to limit a way in which the secondary battery 100 is installed. Moreover, dimensional relationships (length, width, thickness, etc.) in each drawing do not necessarily reflect actual dimensional relationships.

As shown in FIGS. 1 and 2, the secondary battery 100 includes an electrode body 20, an electrolyte (not shown in the drawings), a case body 12 in which the electrode body 20 and the electrolyte are accommodated, a sealing plate 14, a positive electrode terminal 30, a negative electrode terminal 35, and an insulating member 40.

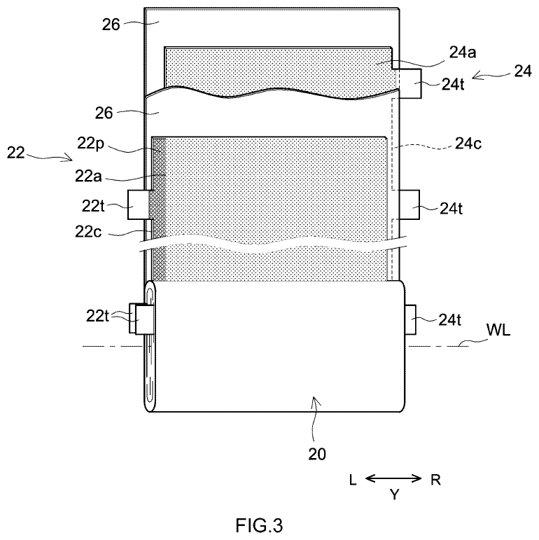

FIG. 3 is a view schematically showing the configuration of the electrode body 20. Here, as shown in FIG. 3, the electrode body 20 is a wound electrode body formed by laminating a strip-shape positive electrode sheet 22 and a strip-shape negative electrode sheet 24 on each other while insulation is provided therebetween across two strip-shape separators 26, and winding the laminated body about a winding axis WL in a lengthwise direction. Alternatively, the electrode body may be a laminated electrode body formed by laminating a square positive electrode sheet and a square negative electrode sheet on each other while insulation is provided therebetween across a square separator. Alternatively, the electrode body may be a laminated electrode body formed by laminating a square positive electrode sheet and a square negative electrode sheet on each other while insulation is provided therebetween across a serpentine separator.

As shown in FIG. 3, the positive electrode sheet 22 is an elongated strip-shape member. The configuration of the positive electrode sheet 22 is not particularly limited but can be similar to that used in a conventional publicly-known battery. For example, the positive electrode sheet 22 has a strip-shape positive electrode substrate 22c, and a positive electrode active material layer 22a and a positive electrode protective layer 22p arranged on at least one surface of the positive electrode substrate 22c. However, the positive electrode protective layer 22p is not essential but is omissible in other embodiments.

The positive electrode substrate 22c is an elongated strip-shape member. The positive electrode substrate 22c is composed of conductive metal such as aluminum, an aluminum alloy, nickel, or stainless steel, for example. Here, the positive electrode substrate 22c is metal foil, more specifically, aluminum foil. The size of the positive electrode substrate 22c is not particularly limited but can be determined properly in response to battery design. The positive electrode substrate 22c has one end portion in the long side direction Y (left end portion in FIG. 3) provided with a plurality of positive electrode tabs 22t. The positive electrode tabs 22t project further in the long side direction Y than the separator 26. The positive electrode tabs 22t are arranged at an interval (intermittently) in a lengthwise direction of the positive electrode substrate 22c. The positive electrode tab 22t forms part of the positive electrode substrate 22c and is composed of the metal foil (aluminum foil). The positive electrode active material layer 22a is formed in part of the positive electrode tab 22t. In at least part of the positive electrode tab 22t, the positive electrode active material layer 22a is not formed and the positive electrode substrate 22c is exposed. The positive electrode tabs 22t are laminated on one end portion of the long side direction Y (left end portion in FIG. 2) to form a positive electrode tab group 23. The positive electrode tabs 22t are folded and bent in such a manner as to align the respective outer edges thereof. The positive electrode tab group 23 is electrically connected to the positive electrode terminal 30 across a positive electrode collector 50.

As shown in FIG. 3, the positive electrode active material layer 22a is provided in a strip shape in the lengthwise direction of the positive electrode substrate 22c. The positive electrode active material layer 22a contains a positive electrode active material. The positive electrode active material to be used can be a publicly-known positive electrode active material used in lithium ion secondary batteries. As a specific example, the positive electrode active material to be used can be a lithium composite oxide or a lithium transition metal phosphate compound. These positive electrode active materials may each be used alone, or two or more types thereof may be used in combination. The positive electrode active material layer 22a may contain a component such as a conductive material or a binder, for example, other than the positive electrode active material. The conductive material to be used suitably may be carbon black such as acetylene black (AB) or other types of carbon materials (e.g., graphite), for example. The binder to be used may be polyvinylidene fluoride (PVDF), for example.

As shown in FIG. 3, the positive electrode protective layer 22p is provided at a boundary between the positive electrode substrate 22c and the positive electrode active material layer 22a in the long side direction Y. The positive electrode protective layer 22p may be a layer configured to be lower in electrical conductivity than the positive electrode active material layer 22a. Here, the positive electrode protective layer 22p is provided at one end portion of the positive electrode substrate 22c in the long side direction Y (left end portion in FIG. 3). Alternatively, the positive electrode protective layer 22p may be provided at the both end portions in the long side direction Y. The positive electrode protective layer 22p is provided in a strip shape along the positive electrode active material layer 22a. The positive electrode protective layer 22p contains an inorganic filler (alumina, for example). The positive electrode protective layer 22p may contain an optional component such as a conductive material, a binder, or each type of additive component, for example, other than the inorganic filler.

As shown in FIG. 3, the negative electrode sheet 24 is an elongated strip-shape member. The configuration of the negative electrode sheet 24 is not particularly limited but can be similar to that used in a conventional publicly-known battery. For example, the negative electrode sheet 24 has a negative electrode substrate 24c, and a negative electrode active material layer 24a arranged on at least one surface of the negative electrode substrate 24c.

The negative electrode substrate 24c is an elongated strip-shape member. The negative electrode substrate 24c is composed of conductive metal such copper, a copper alloy, nickel, or stainless steel, for example. Here, the negative electrode substrate 24c is metal foil, more specifically, copper foil. The size of the negative electrode substrate 24c is not particularly limited but can be determined properly in response to battery design. The negative electrode substrate 24c has one end portion in the long side direction Y (right end portion in FIG. 3) provided with a plurality of negative electrode tabs 24t. The negative electrode tabs 24t project further in the long side direction Y than the separator 26. The negative electrode tabs 24t are arranged at an interval (intermittently) in a lengthwise direction of the negative electrode sheet 24. The negative electrode tab 24t forms part of the negative electrode substrate 24c and is composed of the metal foil (copper foil). The negative electrode active material layer 24a is formed in part of the negative electrode tab 24t. In at least part of the negative electrode tab 24t, the negative electrode active material layer 24a is not formed and the negative electrode substrate 24c is exposed. The negative electrode tabs 24t are laminated on one end portion of the long side direction Y (right end portion in FIG. 2) to form a negative electrode tab group 25. The negative electrode tabs 24t are folded and bent in such a manner as to align the respective outer edges thereof. The negative electrode tab group 25 is electrically connected to a negative electrode terminal 35 across a negative electrode collector 60.

As shown in FIG. 3, the negative electrode active material layer 24a is provided in a strip shape in a lengthwise direction of the strip-shape negative electrode substrate 24c. The negative electrode active material layer 24a contains a negative electrode active material. While the negative electrode active material to be used is not particularly limited, it can be a carbon material such as graphite, hard carbon, or soft carbon, for example. The graphite may either be natural graphite or artificial graphite. The graphite may also be graphite coated with amorphous carbon having a configuration where graphite is coated with an amorphous carbon material. The negative electrode active material to be used may be a material other than carbon-based materials. Examples of the material other than carbon-based materials include lithium titanate (LTO) and silicon-based materials (SiO). The negative electrode active material layer 24a may contain a component such as a binder or a thickening agent, for example, other than the negative electrode active material. The binder to be used may be styrene-butadiene rubber (SBR) or polyvinylidene fluoride (PVDF), for example. The thickening agent to be used may be carboxymethyl cellulose (CMC), for example.

The separator 26 is an insulating resin sheet with a plurality of fine through holes allowing a charge carrier to pass therethrough. The configuration of the separator 26 is not particularly limited but can be similar to that used in a conventional publicly-known battery. For example, the separator 26 is a porous sheet (film) composed of resin such as polyethylene (PE), polypropylene (PP), polyester, cellulose, or polyamide. A heat resistant layer (HRL) may be provided on a surface of the separator 26.

As described above, the secondary battery 100 includes the electrolyte. The electrolyte is not particularly limited but can be similar to that used in a conventional publicly-known battery. The electrolyte may contain a non-aqueous solvent (organic solvent) and an electrolytic salt (supporting salt), for example. For example, ethylene carbonate (EC), diethyl carbonate (DEC), dimethyl carbonate (DMC), or ethyl methyl carbonate (EMC) can be used as the non-aqueous solvent. Various lithium salts can be used as the supporting salt and in particular, lithium salts such as LiPF₆ and LiBF₄ are preferred. The electrolytic solution may contain various types of additives such as a film-forming agent, a gas generating agent, a dispersant, and a thickening agent, for example.

As shown in FIG. 1, a case 10 (here, a battery case 10) includes the case body 12 and the sealing plate 14. Here, the battery case 10 has a rectangular solid (square) outer shape with a closed bottom. The case body 12 is a housing in which the electrode body 20 and the electrolyte are accommodated. The case body 12 is a square container with a closed bottom having one side surface (here, an upper surface) where an opening part 12h is provided (see FIG. 2). Here, the opening part 12h has a substantially rectangular shape. As shown in FIG. 1, the case body 12 includes a substantially rectangular bottom surface 12a in a plan view having long sides and short sides, longer walls 12b in a pair extending upward in the top-bottom direction Z from the long sides of the bottom surface 12a and facing each other, and shorter walls 12c in a pair extending upward in the top-bottom direction Z from the short sides of the bottom surface 12a and facing each other. The area of the shorter wall 12c is smaller than that of the longer wall 12b. While not particularly limited, the case body 12 has an average thickness (average plate thickness) that may generally be equal to or greater than 0.5 mm, for example, equal to or greater than 1 mm from the viewpoint of durability and the like. From the viewpoint of cost or energy density, the average plate thickness may generally be equal to or less than 3 mm and may be equal to or less than 2 mm, for example.

The sealing plate 14 is a substantially rectangular plate member having long side portions in a pair facing each other and short side portions in a pair facing each other. The sealing plate 14 is a member for closing the substantially rectangular opening part 12h of the case body 12. An outer edge of the sealing plate 14 and a peripheral portion of the opening part 12h of the case body 12 are weld connected to each other. As shown in FIG. 2, the sealing plate 14 has two terminal fit holes 18 and 19 penetrating the sealing plate 14 in a thickness direction. The terminal fit holes 18 and 19 are provided one by one at opposite end portions of the sealing plate 14 in the long side direction Y. The terminal fit hole 18 on one side (left side in FIG. 2) is for the positive electrode terminal 30 and the terminal fit hole 19 on the other side (right side in FIG. 2) is for the negative electrode terminal 35. Here, the shapes of the terminal fit holes 18 and 19 in a plan view are substantially perfect circle shapes. Alternatively, the terminal fit holes 18 and 19 may have oval shapes or polygonal shapes such as quadrangular shapes or hexagonal shapes in a plan view. The shapes of the terminal fit holes 18 and 19 may be selected properly in conformity with the shapes of the positive electrode terminal 30 and the negative electrode terminal 35 respectively.

The sealing plate 14 is provided with a liquid filling hole 15 and a gas exhaust valve 17. The liquid filling hole 15 is a through hole through which an electrolytic solution is filled into the battery case 10 after the sealing plate 14 is incorporated with the case body 12. The liquid filling hole 15 is sealed with a sealing member 16 after filling of the electrolytic solution. The gas exhaust valve 17 is configured to rupture if a pressure in the battery case 10 becomes equal to or greater than a predetermined value, thereby exhausting gas in the battery case 10 to the outside.

While not particularly limited, the sealing plate 14 has an average thickness that may generally be equal to or greater than 0.3 mm, for example, equal to or greater than 0.5 mm from the viewpoint of durability and the like. From the viewpoint of cost or energy density, the average thickness may generally be equal to or less than 4 mm and may be equal to or less than 3 mm, for example. The average thickness of the sealing plate 14 may be smaller than an average thickness of the case body 12.

As shown in FIG. 1, the outer edge of the sealing plate 14 and the peripheral portion of the opening part 12h of the case body 12 are weld connected to each other to form a welded part 13 along a boundary (fit part) between the case body 12 and the sealing plate 14. By doing so, the opening part 12h of the case body 12 is closed tightly with the sealing plate 14, allowing the battery case 10 to be sealed hermetically. The welded part 13 may be formed by weld connection such as laser welding, for example. The welded part 13 is a part formed by melting of metal forming the case body 12 and melting of metal forming the sealing plate 14 resulting from laser welding of the fit part between the case body 12 and the sealing plate 14. The welded part 13 is located on an outer surface side of the sealing plate 14. At the welded part 13, an inner periphery of the opening part 12h of the case body 12 and an outer periphery of the sealing plate 14 are coupled to each other in such a manner as to be flush with each other. The welded part 13 is formed along an entire perimeter of the fit part between the sealing plate 14 and the case body 12.

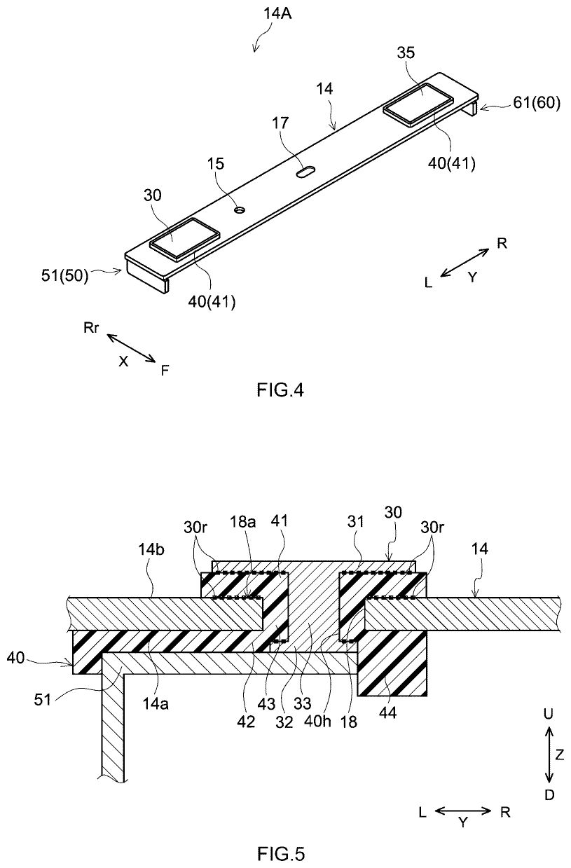

FIG. 4 is a view schematically showing a collector terminal-sealing plate assembly 14A where the sealing plate 14, a collector terminal, and the insulating member 40 are molded integrally. As shown in FIG. 4, the power storage device disclosed herein includes the collector terminal-sealing plate assembly 14A where the sealing plate 14, the collector terminal, and the insulating member 40 are molded integrally. In FIG. 4, the positive electrode collector 50 and the negative electrode collector 60 are molded integrally in addition to the sealing plate 14, the collector terminal, and the insulating member 40.

As shown in FIG. 2, the positive electrode terminal 30 is arranged in such a manner that one end thereof is exposed on the outer surface side of the sealing plate 14 and the other end thereof is connected to the positive electrode 22 of the electrode body 20 inside the case body 12. The positive electrode terminal 30 is connected to the positive electrode tab group 23 composed of the positive electrode tabs 22t across the positive electrode collector 50 inside the battery case 10. As shown in FIG. 2, the positive electrode collector 50 includes a first collector unit 51 extending in the long side direction Y and a second collector unit 52 extending along the shorter wall 12c of the case body 12, for example. The negative electrode terminal 35 is arranged in such a manner that one end thereof is exposed on the outer surface side of the sealing plate 14 and the other end thereof is connected to the negative electrode 24 of the electrode body 20 inside the case body 12. The negative electrode terminal 35 is connected to the negative electrode tab group 25 composed of the negative electrode tabs 24t across the negative electrode collector 60 inside the battery case 10. As shown in FIG. 2, the negative electrode collector 60 includes a first collector unit 61 extending in the long side direction Y and a second collector unit 62 extending along the shorter wall 12c of the case body 12, for example.

The positive electrode collector 50 and the positive electrode terminal 30 are joined to each other, and the negative electrode collector 60 and the negative electrode terminal 35 are joined to each other by welding such as ultrasonic welding, resistance welding, or laser welding, for example. Alternatively, the positive electrode collector 50 and the negative electrode collector 60 may be joined by being molded integrally with the sealing plate 14 together with the positive electrode terminal 30 and the negative electrode terminal 35 respectively in an integral molding step described later. The positive electrode collector 50 and the positive electrode terminal 30, and the negative electrode collector 60 and the negative electrode terminal 35 may also be joined to each other by mechanical working such as swaging (riveting).

FIG. 5 is a sectional view schematically showing the positive electrode terminal 30 and the vicinity thereof. As shown in FIG. 5, the first collector unit 51 of the positive electrode collector 50 is arranged between the sealing plate 14 and the electrode body 20. The first collector unit 51 extends horizontally along an inner surface 14a of the sealing plate 14. As shown in FIG. 5, the insulating member 40 is arranged between the sealing plate 14 and the first collector unit 51. The first collector unit 51 is insulated from the sealing plate 14 by the insulating member 40. The first collector unit 51 is connected to an end portion of the positive electrode terminal 30 on an inner surface side. As shown in FIG. 2, the second collector unit 52 of the positive electrode collector 50 is connected to the first collector unit 51 of the positive electrode collector 50 on one side (upper side in FIG. 2) in the top-bottom direction Z and is connected to the positive electrode tab group 23 on the other side (lower side in FIG. 2). While the configuration described above is on the positive electrode side, a configuration on the negative electrode side may be similar to the configuration on the positive electrode side.

The insulating member 40 is a member that prevents electrical continuity between the sealing plate 14 and the collector terminal (positive electrode terminal 30 and the negative electrode terminal 35). As shown in FIG. 5, the insulating member 40 is arranged at a periphery 18a of the terminal fit hole 18 of the sealing plate 14 while being molded integrally with a peripheral portion of the terminal fit hole 18 and the positive electrode terminal 30. In the present specification, “the periphery of the terminal fit hole” includes not only an edge of the terminal fit hole but also a region around the edge. More specifically, the periphery of the terminal fit hole includes a region within 10 mm (for example, within 5 mm) from an end (edge) of the terminal fit hole.

The insulating member 40 is composed of a fluorine-based resin such as perfluoroalkoxy alkane (PFA) or polytetrafluoroethylene (PTFE) or a synthetic resin material such as polyphenylene sulfide (PPS). Of these materials, the insulating member 40 is preferably composed of polyphenylene sulfide for reason that this material makes it possible to ensure sufficient joint strength.

As shown in FIG. 5, the insulating member 40 includes a first flange part 41, a second flange part 42, a cylindrical part 43, and a projecting part 44. The first flange part 41, the second flange part 42, the cylindrical part 43, and the projecting part 44 are formed integrally. The insulating member 40 has a through hole 40h penetrating the insulating member 40 in the top-bottom direction Z at a position corresponding to the terminal fit hole 18 of the sealing plate 14. The first flange part 41 is arranged on the outer surface side of the sealing plate 14 to insulate an end portion of the positive electrode terminal 30 on an outer side of the case body 12 (hereinafter also called a “sealing plate outer surface side 31”) and an outer surface 14b of the sealing plate 14 from each other. As shown in FIG. 4, the first flange part 41 projects further externally than the positive electrode terminal 30 and the negative electrode terminal 35 in a plan view and is exposed to the outside. As shown in FIG. 5, the second flange part 42 is arranged on an inner surface side of the sealing plate 14 to insulate an end portion of the positive electrode terminal 30 on an inner side of the case body 12 (hereinafter also called a “sealing plate inner surface side 32”) and the inner surface 14a of the sealing plate 14 from each other. The second flange part 42 extends in a horizontal direction along the inner surface 14a of the sealing plate 14. The first flange part 41 and the second flange part 42 have outer shapes larger than the outer shapes of the sealing plate outer surface side 31 and the sealing plate inner surface side 32 of the positive electrode terminal 30 respectively.

The cylindrical part 43 is located between the terminal fit hole 18 and a shaft part 33 of the positive electrode terminal 30. The cylindrical part 43 insulates the terminal fit hole 18 and the shaft part 33 from each other. As shown in FIG. 5, the projecting part 44 is provided closer to the center of the sealing plate 14 than the second flange part 42 in the long side direction Y. The projecting part 44 extends downward in the top-bottom direction Z from one end portion of the second flange part 42 in the long side direction Y (right end portion in FIG. 5). The projecting part 44 may face a bent part of the electrode body 20. Thus, even if the electrode body 20 moves to some extent in response to application of vibration or impact during use of the secondary battery 100, it is still possible to reduce a likelihood that the electrode body 20 will contact the sealing plate 14 directly.

As shown in FIG. 4, the power storage device disclosed herein includes the collector terminal-sealing plate assembly 14A where the sealing plate 14, the collector terminal (positive electrode terminal 30 and negative electrode terminal 35), and the insulating member 40 are molded integrally. Generally, in such a collector terminal-sealing plate assembly, members of the assembly are designed in such a manner that joint strength satisfies a predetermined criterion to join a collector terminal and a sealing plate to each other firmly. Hence, it becomes likely that apparent rigidity will be increased sharply at a part where the sealing plate, the collector terminal, and an insulating member are molded integrally. On the other hand, rigidity is relatively low at a part not involved in the integral molding (welded part, for example). If such a difference in rigidity is generated in a power storage device, at a boundary between the part of high rigidity (namely, the integrally-molded part) and the part of low rigidity (namely, the welded part), the occurrence of stress of some kind inside a case causes concentration of the stress in the part of low rigidity. Hence, rupture is caused easily particularly in the part of low rigidity.

In response to this, in the power storage device disclosed herein, the sealing plate 14, the collector terminal, and the insulating member 40 are molded integrally, and the sealing plate 14 and the collector terminal are composed of materials that satisfy a predetermined relationship therebetween in terms of each of 0.2% proof strength and rupture elongation. This makes it possible to suppress sharp increase in apparent rigidity at the part where the sealing plate 14, the collector terminal, and the insulating member 40 are molded integrally while ensuring strength of a certain level or more in the collector terminal-sealing plate assembly 14A. By doing so, stress concentration in the part of low rigidity is relaxed to allow improvement of the rupture strength of the power storage device favorably.

A metallic material has a tradeoff relationship between proof strength and rupture elongation. In the power storage device disclosed herein, the sealing plate 14 is composed of a material having high 0.2% proof strength and low rupture elongation, and the collector terminal is composed of a material having relatively low 0.2% proof strength and relatively high rupture elongation. Specifically, while the sealing plate 14 is composed of a hard material unlikely to deform, the collector terminal is composed of a soft material likely to deform. More specifically, the sealing plate 14 is composed of a material having proof strength A from 95 to 350 N/mm² and rupture elongation X from 4 to 27%. The collector terminal is composed of a material having proof strength B from 25 to 200 N/mm² and rupture elongation Y from 20 to 45%. The proof strength B is at a ratio from 0.08 to 0.8 to the proof strength A (B/A). The rupture elongation Y is at a ratio from 1.1 to 10.8 to the rupture elongation X (Y/X). This makes it possible to suppress a sharp increase in rigidity while ensuring a predetermined strength of the collector terminal-sealing plate assembly 14A.

The sealing plate 14 is not particularly limited as long as it is composed of a metallic material that fulfills the foregoing respective ranges of 0.2% proof strength and rupture elongation. The sealing plate 14 is a member that ensures the predetermined strength of the collector terminal-sealing plate assembly 14A. The sealing plate 14 may be composed of aluminum, an aluminum alloy, stainless steel, iron, or an iron alloy, for example. More specifically, the sealing plate 14 is preferably composed of ferrite-based stainless steel, an Al—Mn based alloy (A3003, for example), or an Al—Fe based alloy. Even with the same constituent element, the proof strength and the rupture elongation change in response to tempering (working or thermal treatment). As a specific example, the sealing plate 14 is preferably composed of a work-hardened H material as an Al—Mn based alloy (for example, an A3003-H18 material).

From the viewpoint of ensuring the strength of the collector terminal-sealing plate assembly 14A, the proof strength A of the metallic material forming the sealing plate 14 is equal to or greater than 95 N/mm², may be equal to or greater than 125 N/mm², and may be equal to or greater than 145 N/mm². On the other hand, excessively high proof strength causes excessive reduction in rupture elongation. This makes it difficult for the sealing plate 14 to deform, thus rigidity becomes excessively high at the integrally-molded part. From this viewpoint, an upper limit of the proof strength A is equal to or less than 350 N/mm², preferably, equal to or less than 275 N/mm², more preferably, equal to or less than 200 N/mm², and may be equal to or less than 185 N/mm². In the power storage device disclosed herein, the sealing plate 14 is molded integrally with the collector terminal and the insulating member 40. Thus, using the material falling within the foregoing range of proof strength for forming the sealing plate 14 makes it possible to ensure the strength of the collector terminal-sealing plate assembly 14A sufficiently.

From the viewpoint of reducing rigidity at the integrally-molded part, the rupture elongation X of the metallic material forming the sealing plate 14 is at least equal to or greater than 4%. While the rupture elongation X is preferably higher from the viewpoint of reducing rigidity, it is equal to or less than 27% from the viewpoint of ensuring the strength of the collector terminal-sealing plate assembly 14A sufficiently. The rupture elongation X of the sealing plate 14 is 4% to 27%, preferably 4% to 22%, for example, and may be 4% to 10%.

The collector terminal is not particularly limited as long as it is composed of a metallic material that fulfills the foregoing respective ranges of proof strength and rupture elongation. The collector terminal is composed of aluminum, an aluminum alloy, copper, or a copper alloy, for example. More specifically, the positive electrode terminal 30 is preferably composed of pure aluminum. The negative electrode terminal 35 is preferably composed of pure copper such as tough pitch copper or oxygen-free copper, or pure aluminum. As described above, even with the same constituent element, the proof strength and the rupture elongation change in response to tempering. As a specific example, the positive electrode terminal 30 is preferably composed of an annealed O material (for example, an A1050-O material) as pure aluminum. The negative electrode terminal 35 is preferably composed of an annealed O material (for example, an A1050-O material or a C1100-O material) as pure aluminum or tough pitch copper. In the present specification, “pure aluminum” means a material containing Al at a percentage equal to or greater than 99% among constituent elements.

The excessively low proof strength B of the material forming the collector terminal is not preferred as it makes it impossible to ensure the predetermined strength of the collector terminal. From this viewpoint, the proof strength B is at least equal to or greater than 25 N/mm², preferably, equal to or greater than 30 N/mm². On the other hand, the excessively high proof strength B is likely to reduce the rupture elongation, thereby causing a sharp increase in rigidity at a part where the collector terminal is molded integrally with the sealing plate 14 and the insulating member 40. This is not preferred as it increases a difference in rigidity between the integrally-molded part and a part not integrally molded. From this viewpoint, the proof strength B is equal to or less than 200 N/mm², preferably, equal to or less than 150 N/mm², more preferably, equal to or less than 100 N/mm², and may be equal to or less than 70 N/mm². As long as the foregoing ranges are fulfilled, the positive electrode terminal 30 and the negative electrode terminal 35 may be composed of materials having the same proof strength B or materials differing from each other in the proof strength B.

The high rupture elongation Y of the metallic material forming the collector terminal provides the collector terminal with a relatively deformable property. This allows rigidity to be reduced favorably at the part where the collector terminal, the sealing plate 14, and the insulating member 40 are molded integrally. From this viewpoint, the rupture elongation Y is equal to or greater than 20%, preferably, equal to or greater than 28%, more preferably, equal to or greater than 35%. While the rupture elongation Y is preferably higher from the viewpoint of reducing rigidity at the integrally-molded part, it is equal to or less than 45% from the viewpoint of ensuring strength of a certain level or more of the collector terminal. The rupture elongation Y is preferably equal to or less than 43% and may be equal to or less than 40%. As long as the foregoing ranges are fulfilled, the positive electrode terminal 30 and the negative electrode terminal 35 may be composed of materials having the same rupture elongation Y or materials differing from each other in the rupture elongation Y.

In the power storage device disclosed herein, the proof strength A and the proof strength B are adjusted in such a manner as to fulfill a predetermined relationship, thereby suppressing an excessive increase in apparent rigidity at the integrally-molded part. From this viewpoint, a ratio (B/A) of the proof strength B to the proof strength A is equal to or less than 0.8, preferably, equal to or less than 0.66, more preferably, equal to or less than 0.38. On the other hand, the excessively low ratio of the proof strength B to the proof strength A is not preferred as it causes a risk of generating a difference in rigidity between the sealing plate 14 and the collector terminal. From this viewpoint, the ratio (B/A) of the proof strength B to the proof strength A is equal to or greater than 0.08 and may be equal to or greater than 0.1, more preferably, equal to or greater than 0.24. If the positive electrode terminal 30 and the negative electrode terminal 35 are composed of materials differing from each other in the proof strength B, the relationship between the proof strength A and the proof strength B may be adjusted so as to satisfy the above-described range. That is, a relationship between the proof strength A and the proof strength B of the material forming the positive electrode terminal 30 may be adjusted so as to satisfy the foregoing ranges. And a relationship between the proof strength A and the proof strength B of the material forming the negative electrode terminal 35 may be adjusted so as to satisfy the foregoing ranges.

In the power storage device disclosed herein, the rupture elongation X and the rupture elongation Y are adjusted in such a manner as to fulfill a predetermined relationship, thereby allowing apparent rigidity to be reduced favorably at the integrally-molded part. From this viewpoint, a ratio (Y/X) of the rupture elongation Y to the rupture elongation X is equal to or greater than 1.1, preferably, equal to or greater than 1.29, more preferably, equal to or greater than 1.59. The excessively high ratio of the rupture elongation Y to the rupture elongation X is not preferred as causes a risk of generating a difference in rigidity between the sealing plate 14 and the collector terminal. From this viewpoint, the ratio (Y/X) of the rupture elongation Y to the rupture elongation X is equal to or less than 10.8, may be equal to or less than 8.8, may be equal to or less than 7, and may be equal to or less than 4.3. If the positive electrode terminal 30 and the negative electrode terminal 35 are composed of materials differing from each other in the rupture elongation Y, adjustment may be made in such as manner that a relationship between the rupture elongation X and the rupture elongation Y of the material forming the positive electrode terminal 30 and a relationship between the rupture elongation X and the rupture elongation Y of the material forming the negative electrode terminal 35 both fulfill the foregoing ranges.

As a combination of materials to fulfill the predetermined relationships between the proof strength A and the proof strength B and between the rupture elongation X and the rupture elongation Y, the sealing plate 14 may be composed of ferrite-based stainless steel (proof strength A: 275 N/mm² to 350 N/mm², rupture elongation X: 27% to 30%), the positive electrode terminal 30 may be composed of pure aluminum (proof strength B: 30 N/mm² to 35 N/mm², rupture elongation Y: 35% to 43%), and the negative electrode terminal 35 may be composed of tough pitch copper (proof strength B: 15 N/mm², rupture elongation Y: 35%), for example. Furthermore, the sealing plate 14 may be composed of an Al—Mn based alloy (proof strength A: 125 N/mm² to 185 N/mm², rupture elongation X: 4% to 10%), and the collector terminal (positive electrode terminal 30 and the negative electrode terminal 35) may be composed of the foregoing pure aluminum.

While not particularly limited, the material forming the collector terminal has a Young's modulus that is preferably lower than the Young's modulus of the material forming the sealing plate 14. A material having a higher Young's modulus can be said to be a material less likely to deform. Thus, the collector terminal is composed of the material more deformable than the material forming the sealing plate 14. The Young's modulus of the material forming the collector terminal may be equal to or less than half and may be equal to or less than 1/10 of the Young's modulus of the material forming the sealing plate 14.

As shown in FIG. 5, in the collector terminal-sealing plate assembly 14A, a roughened area 30r resulting from roughening treatment is preferably arranged in at least a part of surfaces of the sealing plate 14 and/or the collector terminal. The roughening treatment is a surface treatment of forming irregularities on a surface to increase a surface area and enhance an anchor effect, thereby improving performance of joining or tight contact between the insulating member 40 and the sealing plate 14. Thus, the roughened area 30r is an area with more irregularities than a surrounding of the roughened area 30r.

While not particularly limited, the roughened area 30r may be arranged in at least a part of a surface of the collector terminal contacting the insulating member 40. This improves hermeticity favorably between the collector terminal and the insulating member 40. The roughened area 30r may be arranged in the sealing plate outer surface side 31 or the sealing plate inner surface side 32 of the collector terminal, in the shaft part 33, or in all of surfaces of the sealing plate outer surface side 31, the sealing plate inner surface side 32, and the shaft part 33 contacting the insulating member 40. In a place where the roughened area 30r is arranged, the anchor effect is exerted as described above so rigidity is likely to increase particularly in this place. Thus, by providing the roughened area 30r in at least a part of the surface of the collector terminal contacting the insulating member 40, effect by adjusting the respective proof strengths of the sealing plate 14 and the collector terminal and rupture strength within the foregoing ranges may be exerted further.

While not particularly limited, the roughened area 30r may be provided in the sealing plate 14. Preferably, the roughened area 30r is provided in at least a part of a surface of the thin part 14s contacting the insulating member 40, for example. By doing so, hermeticity may be improved between the sealing plate 14, the collector terminal, and the insulating member 40.

### <Method of Manufacturing Power Storage Device>

A lithium ion secondary battery will be described below as an example of a preferred embodiment of a method of manufacturing the power storage device disclosed herein. However, this is not intended to limit a target of application of the method to such a battery.

The method of manufacturing the secondary battery 100 may include a step of preparing the sealing plate 14, the positive electrode terminal 30, the negative electrode terminal 35, and other required members, a step of integrally molding the sealing plate 14 and the collector terminal, and a step of assembling the collector terminal-sealing plate assembly 14A resulting from the integral molding and the case body 12. The method may include a different additional step in an optional stage.

In the preparing step, the sealing plate 14, the positive electrode terminal 30, the negative electrode terminal 35, and the electrode body 20 are prepared. The sealing plate 14, the positive electrode terminal 30, and the negative electrode terminal 35 prepared here are those composed of materials that fulfill the foregoing ranges in terms of 0.2% proof strength and rupture elongation. Furthermore, the positive electrode terminal 30 and the negative electrode terminal 35 to be prepared are those having end portions on a side to be arranged inside the case body 12 capable of being inserted in the terminal fit holes 18 and 19 respectively.

The electrode body 20 can be produced by following a publicly-known method. As shown in FIG. 3, if the electrode body 20 is a wound electrode body, the wound electrode body can be prepared as follows, for example. First, the strip-shape positive electrode sheet 22 and the strip-shape negative electrode sheet 24 are laminated on each other while insulation is provided therebetween across the two strip-shape separators 26. At this time, the positive electrode sheet 22 and the negative electrode sheet 24 are superimposed on each other in such a manner that the positive electrode tab 22t of the positive electrode sheet 22 and the negative electrode tab 24t of the negative electrode sheet 24 stick out from the end portions of the two separators 26 in the long side direction Y toward directions opposite to each other. Next, the prepared laminated body is wound in the lengthwise direction about a winding axis. The laminated body can be wound by following a publicly-known method. The wound laminated body is pressed to produce a wound electrode body having a flat shape. This pressing is not particularly limited but can be performed using a publicly-known press unit used in manufacturing a general wound electrode body having a flat shape. In this way, the electrode body 20 can be prepared.

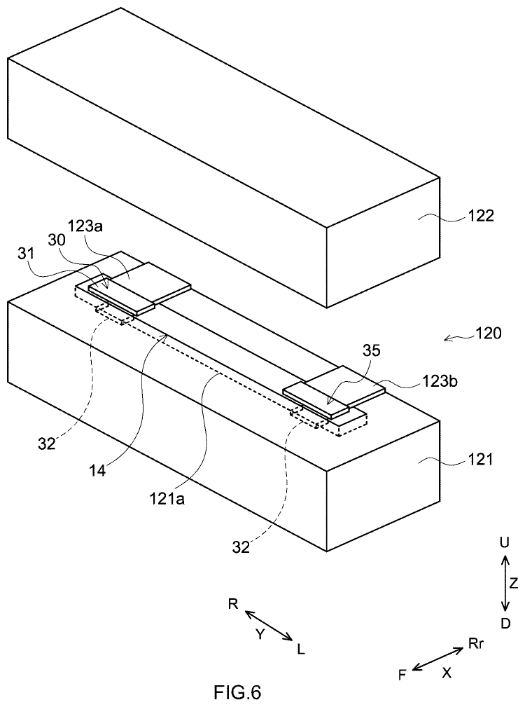

FIG. 6 is a view schematically showing a molding die 120. In the integral molding step, the sealing plate 14 and the collector terminal are integrated with each other through insert molding to produce the collector terminal-sealing plate assembly 14A. The insert molding can be performed by following a publicly-known method. More specifically, the insert molding can be performed using the molding die 120 with a lower die 121 and an upper die 122 such as those shown in FIG. 6 and by following a method including a component setting step, a positioning step, an upper die setting step, an injection molding step, an upper die releasing step, and a component extracting step.

In the component setting step, the sealing plate 14 and the collector terminal are loaded into the molding die 120. First, the collector terminal is inserted into the terminal fit hole 18 of the sealing plate 14. As described above, the collector terminal is formed into a size allowing the sealing plate inner surface side 32 to be inserted in the terminal fit hole 18. Thus, the collector terminal is inserted into each of the two terminal fit holes 18 and 19 from the sealing plate inner surface side 32. Then, the sealing plate 14 with the collector terminal inserted in each of the two terminal fit holes 18 and 19 is loaded into a recess 121a of the lower die 121.

In the positioning step, the sealing plate 14 and the collector terminal are placed into positions. After the sealing plate 14 and the collector terminal are loaded in the lower die 121, the positioning step is started in response to predetermined operation such as switch depression, for example. More specifically, in response to the predetermined operation such as switch depression, a slide member 123a and a slide member 123b at backward retreating positions move forward. Then, the collector terminals are caught by the respective slide members 123a and 123b. The collector terminals are supported by the respective slide members 123a and 123b and located at intended positions.

In the upper die setting step, the upper die 122 is set in such a manner as to interpose the sealing plate 14 and the collector terminal in the top-bottom direction Z placed in the lower die 121. While not shown in the drawings, the upper die 122 may have a seal part to abut on the lower die 121, a resin supplier to supply resin, and a recess into which the supplied resin is to flow. The recess of the upper die 122 is arranged in such a manner as to face the recess 121a of the lower die 121 across the sealing plate 14 and the collector terminal.

In the injection molding step, resin is supplied (injected) from the resin supplier to mold the sealing plate 14 and the collector terminal integrally. In the injection molding step, the molding die 120 is heated first. While a heating temperature is not particularly limited as it differs according to a resin type, it may approximately be from 100 to 200° C., for example. After heating of the molding die 120 is finished, melted resin is supplied from the resin supplier. The resin supplied here is preferably synthetic resin such as polyphenylene sulfide (PPS), polyetherimide (PEI), or polyamide imide (PAI). This allows the integrally-molded part to be provided with higher toughness. The supplied resin is filled into the recess of the upper die 122 and further filled into the recess 121a of the lower die 121 through the terminal fit hole 18. Then, the molding die 120 and the molded item are cooled. By doing so, the sealing plate 14 and the collector terminal can be molded integrally.

In the upper die releasing step, the upper die 122 moves up to be separated from the lower die 121. Next, in the component extracting step, the molded item is detached from the lower die 121. As a result, the collector terminal-sealing plate assembly 14A can be produced where the collector terminal and the sealing plate 14 are molded integrally. A step of removing burrs occurring during the molding may be performed after the component extracting step.

In the assembling step, while the prepared electrode body 20 is accommodated inside the case body 12, the collector terminal-sealing plate assembly 14A is mounted on the case body 12 and the case body 12 is closed. More specifically, first, the positive electrode tab group 23 of the electrode body 20 and the second collector unit 52 of the positive electrode collector 50 are connected to each other, and the negative electrode tab group 25 of the electrode body 20 and the second collector unit 62 of the negative electrode collector 60 are connected to each other. Next, the first collector unit 51 of the positive electrode collector 50 is mounted on the positive electrode terminal 30 of the collector terminal-sealing plate assembly 14A, and the first collector unit 61 of the negative electrode collector 60 is mounted on the negative electrode terminal 35 of the collector terminal-sealing plate assembly 14A. Then, the first collector unit 51 and the second collector unit 52 of the positive electrode collector 50 are connected to each other, and the first collector unit 61 and the second collector unit 62 of the negative electrode collector 60 are connected to each other. By doing so, it becomes possible to connect the collector terminal-sealing plate assembly 14A and the electrode body 20 to each other. The electrode body 20 mounted on the collector terminal-sealing plate assembly 14A is inserted through the opening part 12h of the case body 12. At this time, the electrode body 20 may be inserted in such a manner as to be placed inside the case body 12 in a direction in which the winding axis WL of the electrode body 20 extends along the bottom surface 12a (specifically, in a direction in which the winding axis WL extends parallel to the long side direction Y). While the electrode body 20 is accommodated inside the case body 12, the collector terminal-sealing plate assembly 14A and the periphery of the opening part 12h of the case body 12 are joined to each other by laser welding, for example. Then, the electrolytic solution is filled from the liquid filling hole 15 and the liquid filling hole 15 is sealed with the sealing member 16, thereby hermetically sealing the secondary battery 100. In this way, the secondary battery 100 can be manufactured.

### <Purpose of Use of Battery>

The power storage device is available for various purposes of use and can be used suitably as a power source (driving power source) for motors installed on vehicles such as passenger cars or trucks, for example. While a vehicle type is not particularly limited, examples thereof include plug-in hybrid electric vehicles (PHEV), hybrid electric vehicles (HEV), and battery electric vehicles (BEV), for example. The power storage device is also used suitably in a configuration formed by arranging a plurality of such power storage devices in a predetermined arrangement direction and applying a load in the arrangement direction from a binding mechanism (for example, an assembled battery configured by arranging a plurality of lithium ion secondary batteries in a predetermined direction).

While some embodiments of the present disclosure have been described above, the embodiments are mere examples. The present disclosure can be carried out in various other embodiments. The present disclosure can be carried out on the basis of the contents disclosed in the present specification and technical knowledge in the pertinent field. The technology described in the claims include various modifications and changes from the embodiments described above as examples. For example, it is possible to replace some of the embodiments with other modifications or add other modifications to the embodiments. Unless one technical feature is described as being essential, this feature can be eliminated, as appropriate.

What is claimed is:

1. A power storage device comprising:
a case body having an opening part;
a metallic sealing plate having a terminal fit hole and closing the opening part;
an electrode body accommodated inside the case body;
a collector terminal having one end electrically connected to the electrode body inside the case body and the other end exposed on an outer surface side of the sealing plate; and
an insulating member arranged between the sealing plate and the collector terminal, wherein
the insulating member is arranged at a periphery of the terminal fit hole of the sealing plate while being molded integrally with a peripheral portion of the terminal fit hole and the collector terminal,
the sealing plate is composed of a metallic material having 0.2% proof strength A from 95 to 350 N/mm² and rupture elongation X from 4 to 27%,
the collector terminal is composed of a metallic material having 0.2% proof strength B from 25 to 200 N/mm² and rupture elongation Y from 20 to 45%,
a ratio (B/A) of the proof strength B to the proof strength A is from 0.08 to 0.8, and
a ratio (Y/X) of the rupture elongation Y to the rupture elongation X is from 1.1 to 10.8.

2. The power storage device according to claim 1, wherein
a roughened area having more irregularities than a surface of a surrounding of the roughened area is arranged in at least a part of a surface of the collector terminal contacting the insulating member.
